(19) United States
(12) Patent Application Publication
(10) Pub. No.: US 2015/0249334 A1
(43) Pub. Date: Sep. 3, 2015

(54) ELECTROSTATIC DISCHARGE CIRCUIT WITH REDUCED STANDBY CURRENT

(71) Applicant: Qualcomm Incorporated, San Diego, CA (US)

(72) Inventors: Wen-Yi Chen, San Diego (US); Sreeker Dundigal, San Diego, CA (US); Reza Jalilizeinali, Oceanside, CA (US); Eugene Robert Worley, Irvine, CA (US)

(73) Assignee: QUALCOMM INCORPORATED, San Diego, CA (US)

(21) Appl. No.: 14/194,158

(22) Filed: Feb. 28, 2014

(51) Int. Cl. H02H 9/04

(52) U.S. Cl. CPC H02H 9/046

(57) ABSTRACT

Techniques for reducing leakage current during normal operation of an electrostatic discharge (ESD) circuit are described herein. In one embodiment, a circuit comprises an internal circuit and an electrostatic discharge (ESD) rail clamp coupled in parallel to the internal circuit and between first and second power supply rails. The ESD rail clamp is operable to shunt ESD current from the first power supply rail to the second power supply rail via a low resistance shunt path. The ESD rail clamp comprises an ESD trigger circuit configured to detect an ESD event and a plurality of discharging transistors coupled in series. The ESD trigger circuit is configured to turn off the discharging transistors during normal operation and to turn on the discharging transistors to form the low resistance shunt path in response to detection of the ESD event.

### FIELD

Aspects of the present disclosure relate generally to clamp circuits, and more particularly, to an electrostatic discharge clamp circuit with reduced standby current.

### BACKGROUND

A semiconductor device may include circuits that are susceptible to damage from an electrostatic discharge (ESD) event (such as during fabrication, packaging, or handling of the device). For example, a current caused by the ESD event may damage or destroy gate oxide, metallization, or junctions of electronic components. Damage caused by the ESD event may reduce manufacturing yields or cause operational failures of the electronic components.

Accordingly, on-chip ESD rail clamps are necessary for integrated circuits (ICs) to meet desired ESD protection levels. Each pin or bump of an IC exposed to an outside environment should be properly protected with adequate ESD protection elements. Due to the high current nature of an ESD event, a robust and efficient ESD rail clamp is fundamental to a whole-chip ESD protection network. However static power consumption due to leakage current of an ESD rail clamp is undesirable, especially in low-power applications. As transistors scale down, the transistors tend to become leakier (e.g., due to thinner oxide walls). As a result, the transistors can leak current even when the transistors are turned off, thus leading to static power loss.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to an aspect, a circuit is described herein. The circuit comprises an internal circuit and an electrostatic discharge (ESD) rail clamp coupled in parallel to the internal circuit and between first and second power supply rails. The ESD rail clamp is operable to shunt ESD current from the first power supply rail to the second power supply rail via a low resistance shunt path. The ESD rail clamp comprises an ESD trigger circuit configured to detect an ESD event and a plurality of discharging transistors coupled in series. The ESD trigger circuit is configured to turn off the discharging transistors during normal operation and to turn on the discharging transistors to form the low resistance shunt path in response to detection of the ESD event.

A second aspect relates to a method for reducing standby current in an electrostatic discharge circuit. The method comprises detecting an ESD event, and in response to detecting the ESD event, activating discharging transistors to provide a low resistance shunt path during the ESD event. The discharging transistors are deactivated during normal operation. The method also includes shunting ESD current from a first power supply rail to a second power supply rail via the low resistance shunt path during the ESD event.

A third aspect relates to an apparatus for reducing standby current in an electrostatic discharge circuit. The apparatus comprises means for detecting an ESD event, and in response to detecting the ESD event, means for activating discharging transistors to provide a low resistance shunt path during the ESD event. The discharging transistors are deactivated during normal operation. The apparatus also includes means for shunting ESD current from a first power supply rail to a second power supply rail via the low resistance shunt path during the ESD event.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a circuit diagram illustrating an example of a device that includes an internal circuit and an ESD clamp in accordance with one or more embodiments of the subject technology.

FIG. 2 is a circuit diagram illustrating an example of an ESD clamp in accordance with one or more embodiments of the subject technology.

FIG. 3 is a circuit diagram illustrating an example of an ESD clamp that includes series discharging transistors in accordance with one or more embodiments of the subject technology.

FIG. 4 is a circuit diagram illustrating an example of an ESD clamp that includes a PMOS discharging transistor and an NMOS discharging transistor coupled in series in accordance with one or more embodiments of the subject technology.

FIG. 5 is a circuit diagram illustrating another example of an ESD clamp that includes a PMOS discharging transistor and an NMOS discharging transistor coupled in series in accordance with one or more embodiments of the subject technology.

FIG. 6 is a circuit diagram illustrating an example of an ESD clamp that includes PMOS discharging transistors coupled in series in accordance with one or more embodiments of the subject technology.

FIG. 7 is a circuit diagram illustrating another example of an ESD clamp that includes PMOS discharging transistors coupled in series in accordance with one or more embodiments of the subject technology.

FIG. 8 is a circuit diagram illustrating an example of an ESD clamp that includes a PMOS discharging transistor having a gate coupled to a third power supply rail in accordance with one or more embodiments of the subject technology.

FIG. 9 is a circuit diagram illustrating another example of an ESD clamp that includes a PMOS discharging transistor having a gate coupled to a third power supply rail in accordance with one or more embodiments of the subject technology.

FIG. 10 is a circuit diagram illustrating an example of an ESD clamp that includes a high-pass ESD trigger circuit in accordance with one or more embodiments of the subject technology.

FIG. 11 is a circuit diagram illustrating another example of an ESD clamp that includes a high-pass ESD trigger circuit in accordance with one or more embodiments of the subject technology.

FIG. 12 is a flowchart illustrating an example of a method of shunting ESD current between voltage power supply rails in accordance with one or more embodiments of the subject technology.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

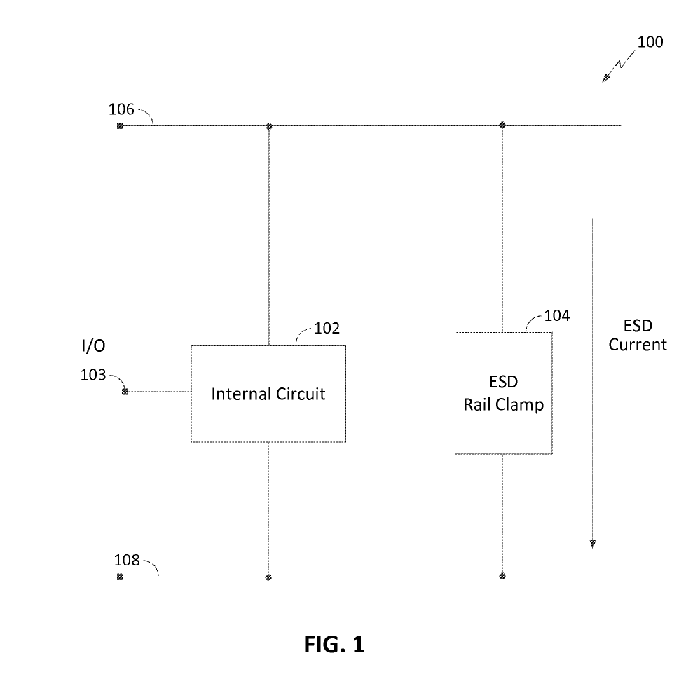

FIG. 1 shows an example of an ESD discharging network where integrated circuit 100 includes internal circuit 102, input/output (I/O) node 103, and ESD rail clamp 104 coupled in parallel to internal circuit 102. ESD rail clamp 104 is configured to provide ESD protection to internal circuit 102.

During an ESD event, ESD rail clamp 104 provides a discharging path between power supply rail 106 (e.g., VDD) and power supply rail 108 (e.g., VSS) to complete the ESD discharging network. When an ESD current (e.g., an electrical signal with high amplitude for a short period of time with a rapid rise time) is present on power supply rail 106, ESD rail clamp 104 diverts the ESD current through the discharging path such that the ESD current flows away from internal circuit 102. In this regard, the discharging path may provide a low resistance shunt path between power supply rails 106 and 108. Rail clamp 104 may be designed to handle ESD events described by Joint Electronic Devices Engineering Council (JEDEC) EDS test specifications, including a Human Body Model (HBM) standard (e.g., 1 kV), a Charged Device Model (CDM) standard (e.g., 250V), and a Machine Model (MM).

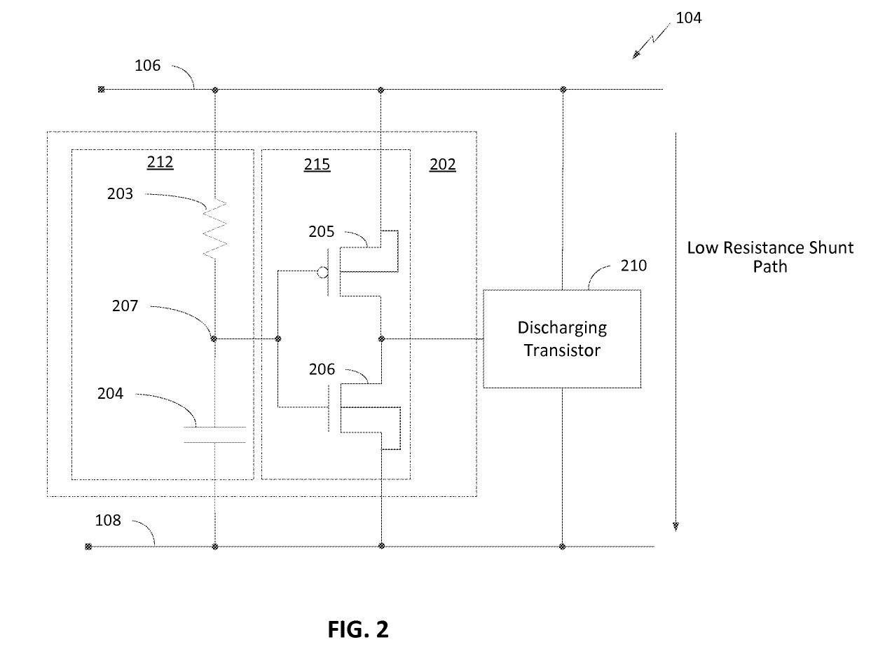

FIG. 2 shows an example of ESD rail clamp 104. ESD rail clamp 104 includes an ESD trigger circuit 202 and a discharging transistor 210 (e.g., NMOS transistor) with the discharging transistor 210 coupled in parallel to the ESD trigger circuit 202.

In some aspects, the ESD trigger circuit 202 includes a resistor-capacitor (RC) network 212 configured to detect an ESD event. The RC network 212 is coupled between power supply rail 106 and power supply rail 108. The RC network 212 includes a resistor 203 and a capacitor 204. The resistor 203 and the capacitor 204 may be coupled in series between power supply rail 106 and power supply rail 108 such that the RC network 212 behaves as a low-pass filter at node 207. In this regard, the RC network 212 is configured to pass the supply voltage on power supply rail 106 to node 207 while blocking ESD signals from node 207. For example, the RC network 212 may have an RC time constant of a few microseconds.

The ESD trigger 202 also includes a control circuit 215 coupled to node 207. As shown in FIG. 2, the control circuit 215 includes transistors 205 and 206 coupled in series. In some aspects, transistor 205 is a PMOS transistor and transistor 206 is an NMOS transistor to form an inverter stage, with each transistor having a gate node coupled to node 207 and a drain node coupled to the gate node of the discharging transistor 210 (e.g., NMOS transistor). In some implementations, the body of each transistor is coupled to the source node of the respective transistor.

During normal operation, the ESD trigger circuit 202 keeps discharging transistor 210 turned off. This is because the RC network 212 passes the supply voltage on power supply rail 106 to node 207 by charging capacitor 204 to the supply voltage. The supply voltage at node 207 turns off transistor 205 and turns on transistor 206 of the inverter stage, causing transistor 206 to pull the output of the inverter stage low. The low voltage is input to the gate of discharging transistor 210 (e.g., NMOS transistor), keeping discharging transistor 210 turned off. As used herein, the term “normal operation” may refer to operation outside of an ESD event.

In some aspects, the ESD rail clamp 104 is configured to provide ESD protection to internal circuit 102 when power supply rail 106 is powered off (e.g., during manufacturing and/or handling of the device incorporating internal circuit 102). In this aspect, when an ESD event is not present, node 207 is at zero potential and discharging transistor 210 is turned off since power supply rail 106 is powered off.

However, during an ESD event occurring when power supply rail 106 is powered off (e.g., during manufacturing and/or handling of the device incorporating internal circuit 102), the ESD trigger circuit 202 turns on discharging transistor 210 to provide the low resistance shunt path from power supply rail 106 to power supply rail 108. In particular, the RC network 212 blocks (filters out) the high-frequency components of the ESD current thus keeping the voltage at node 207 at zero potential. However, the ESD voltage rises above the absolute threshold voltage of transistor 205, causing transistor 205 to turn on. In some aspects, transistor 206 remains turned off during the ESD event. Transistor 205 pulls the gate node of the discharging transistor 210 high (e.g., to the voltage value of the power supply rail 106), causing the discharging transistor 210 to turn on. As a result, discharging transistor 210 completes the low resistance path to shunt the ESD current away from internal circuit 102 (shown in FIG. 1).

As transistors scale down, the transistors become increasingly leaky (e.g., thinner gate dielectrics and shorter channel lengths). As a result, the transistors can leak current even when turned off, thus leading to static power loss. In this regard, leakage current of an ESD rail clamp during normal operating conditions consumes unwanted static power. In some aspects, the discharging transistor 210 has a large effective width that causes a non-negligible leakage current. As such, reducing the static power consumption in a low-power or leakage-aware design such as integrated circuit 100 becomes increasingly difficult when ICs include an increasing number of on-chip ESD rail clamps.

Some conventional solutions have included approaches that attempt to reduce the amount of leakage current during normal operation of an ESD circuit. In one approach, a single PMOS transistor is used as the primary discharging transistor. However, only marginal leakage current reduction is achieved for smaller design processes. In another approach, the NMOS transistor as the primary discharging transistor is implemented with a thicker oxide and longer channel length. However, this increases the amount of space used to implement the discharging transistor, especially for higher drive designs.

To address the above drawbacks associated with static power loss, embodiments of the present disclosure reduce the leakage current by implementing series transistors in the discharging path, as discussed further below. The series discharging transistors are configured to reduce the leakage current produced during normal operation since the supply voltage is split between the series discharging transistors.

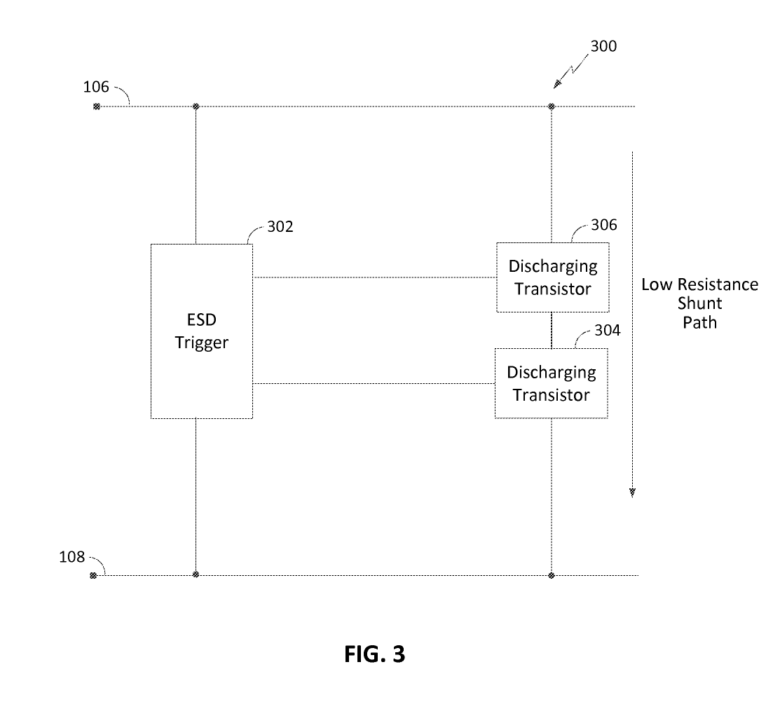

FIGS. 3-11 are circuit diagrams illustrating examples of ESD clamps that include series discharging transistors in accordance with various embodiments of the subject technology. FIG. 3 shows an example of an ESD rail clamp 300 comprising discharging transistors 304 and 306 coupled in series between the power supply rails 106 and 108. ESD rail clamp 300 also comprises an ESD trigger circuit 302 coupled in parallel to discharging transistors 304 and 306. During normal operation, the ESD trigger circuit 302 keeps discharging transistors 304 and 306 turned off. During an ESD event, the ESD trigger circuit 302 turns on discharging transistors 304 and 306 to provide the low resistance shunt path from power supply rail 106 to power supply rail 108. In contrast to ESD rail clamp 104 shown in FIG. 2, the amount of leakage current produced during normal operation (e.g., when discharging transistors 304 and 306 are turned off) is reduced since the supply voltage (e.g., VDD) is split between discharging transistors 304 and 306, thereby improving the static power consumption of an integrated circuit chip.

While reducing leakage current, placing the discharging transistors 304 and 306 in series in the shunt path may reduce conductivity to an ESD current. This is because, when discharging transistors 304 and 306 are turned on during an ESD event, the channel resistances of discharging transistors 304 and 306 are in series, which increases the overall resistance of the shunt path. To address this, the channel length of each discharging transistor 304 and 306 may be shorter compared to discharging transistor 210 (shown in FIG. 2). For example, each discharging transistor 304 and 306 may have a channel length (e.g., 36 nm) that is approximately half the channel length (e.g., 72 nm) of discharging transistor 210. Reducing the channel length of each discharging transistor 304 and 306 reduces the channel resistance of each transistor, thereby reducing the overall resistance of the shunt path.

In some aspects, discharging transistors 304 and 306 may include an NMOS transistor and a PMOS transistor coupled in series. In this regard, the ESD rail clamp 300 can have a better tolerance to bus voltage spikes than the ESD rail clamp 104 because of the NMOS and PMOS transistors in series. In other aspects, discharging transistors 304 and 306 may include two PMOS transistors coupled in series. In some aspects, the ESD trigger circuit 302 may include an RC network for detecting an ESD event on the supply rails, and one or more inverter stages configured to turn on discharging transistors 304 and 306 when the RC network detects an ESD event and turn off discharging transistors 304 and 306 when an ESD event is not detected.

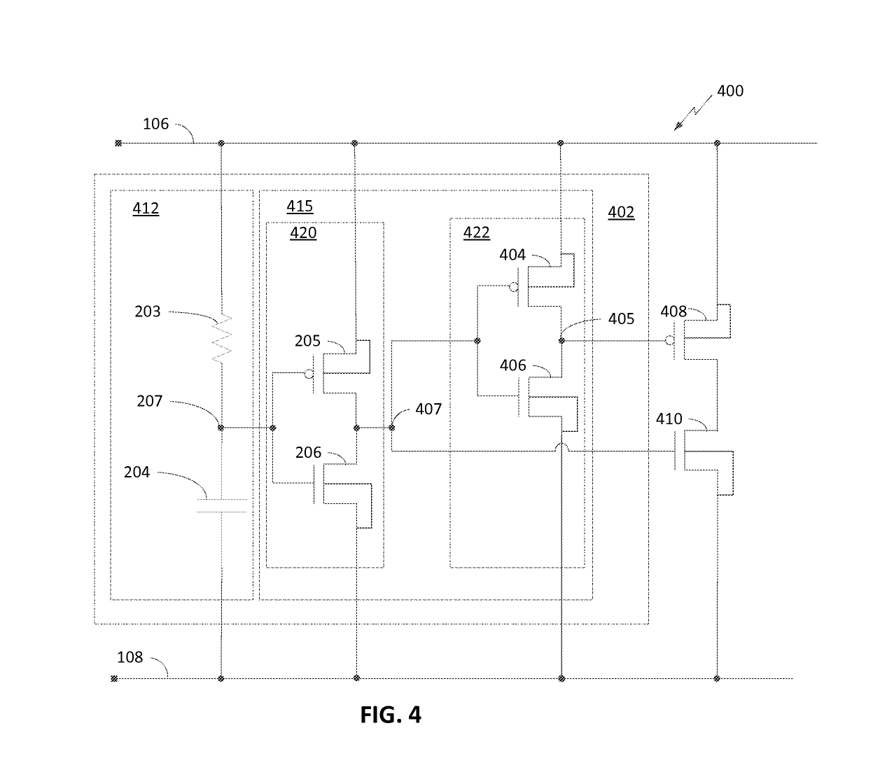

FIG. 4 shows an example of an ESD rail clamp 400 having series transistors in the discharging path. The ESD rail clamp 400 includes an ESD trigger circuit 402 and discharging transistors 408 and 410. The ESD trigger circuit 402 is coupled in parallel to discharging transistors 408 and 410, which are coupled in series. The ESD trigger circuit 402 includes an RC network 412 for detecting an ESD event on the power supply rails, and a control circuit 415 configured to turn on discharging transistors 408 and 410 when the RC network 412 detects an ESD event and turn off discharging transistors 408 and 410 when an ESD event is not detected. In some aspects, discharging transistor 408 is a PMOS transistor and discharging transistor 410 is an NMOS transistor.

The RC network 412 is coupled between power supply rail 106 and power supply rail 108. The RC network 412 includes a resistor 203 and a capacitor 204. The resistor 203 and capacitor 204 may be coupled in series between power supply rail 106 and power supply rail 108 such that the RC network behaves as a low-pass filter at node 207. In this respect, the resistor 203 is coupled between power supply rail 106 and node 207, while the capacitor 204 is coupled between power supply rail 108 and node 207. The RC network 412 is configured to pass the supply voltage on power supply rail 106 to node 207 while blocking ESD signals from node 207.

As shown in FIG. 4, the control circuit 415 includes transistors 205 and 206 coupled in series and transistors 404 and 406 coupled in series. In some aspects, transistor 205 is a PMOS transistor and transistor 206 is an NMOS transistor to form a first inverter stage 420, and transistor 404 is a PMOS transistor and transistor 406 is an NMOS transistor to form a second inverter stage 422. Each of transistors 205 and 206 has a gate node coupled to node 207 and a drain node coupled to the gate nodes of transistors 404 and 406 and the gate node of discharging transistor 410. In some aspects, the drain nodes of transistors 404 and 406 are commonly coupled to the gate node of discharging transistor 408. In some implementations, the body of each transistor 205, 206, 404 and 406 is coupled to the source node of the respective transistor.

During normal operation, the ESD trigger circuit 402 keeps discharging transistors 408 and 410 turned off. This is because the RC network 412 passes the supply voltage on power supply rail 106 to node 207 by charging capacitor 204 to the supply voltage. The supply voltage at node 207 turns off transistor 205 and turns on transistor 206 of the first inverter stage 420, causing transistor 206 to pull node 407 at the output of the first inverter stage 420 low. The low voltage at node 407 is input to the gate node of discharging transistor 410 (e.g., NMOS transistor), keeping discharging transistor 410 turned off. The low voltage at node 407 is also input to the second inverter stage 422. The low voltage turns on transistor 404 and turns off transistor 406, causing transistor 404 to pull node 405 at the output of the second inverter stage 422 high. The high voltage at node 405 is input to the gate node of discharging transistor 408 (e.g., PMOS transistor), keeping discharging transistor 408 turned off. In contrast to FIG. 2, the ESD rail clamp 400 splits the supply voltage (the voltage between 106 and 108) across discharging transistors 408 and 410 to reduce the amount of leakage current produced during normal operation.

In some aspects, the ESD rail clamp 400 is configured to provide ESD protection to internal circuit 102 when power supply rail 106 is powered off (e.g., during manufacturing and/or handling of the device incorporating internal circuit 102). In this aspect, when an ESD event is not present, node 207 is at zero potential and discharging circuits 408 and 410 are turned off since power supply rail 106 is powered off.

However, during an ESD event occurring when power supply rail 106 is powered off (e.g., during manufacturing and/or handling of the device incorporating internal circuit 102), the ESD trigger circuit 402 turns on discharging transistors 408 and 410 to provide the low resistance shunt path from power supply rail 106 to power supply rail 108. In particular, the RC network 412 blocks the high-frequency components of the ESD current, thus keeping the voltage at node 207 at zero potential. However, the ESD voltage rises above the absolute threshold voltage of transistor 205, causing transistor 205 to turn on. In some aspects, transistor 206 remains turned off during the ESD event. As a result, transistor 205 pulls node 407 high (e.g., to the voltage value of the power supply rail 106), causing discharging transistor 410 (e.g., NMOS transistor) to turn on and transistor 406 of the second inverter stage 422 to turn on. As a result, transistor 406 pulls node 405 low (e.g., to the voltage value of the power supply rail 108), causing discharging transistor 408 (e.g., PMOS) to turn on to complete the low resistance shunt path between power supply rails 106 and 108.

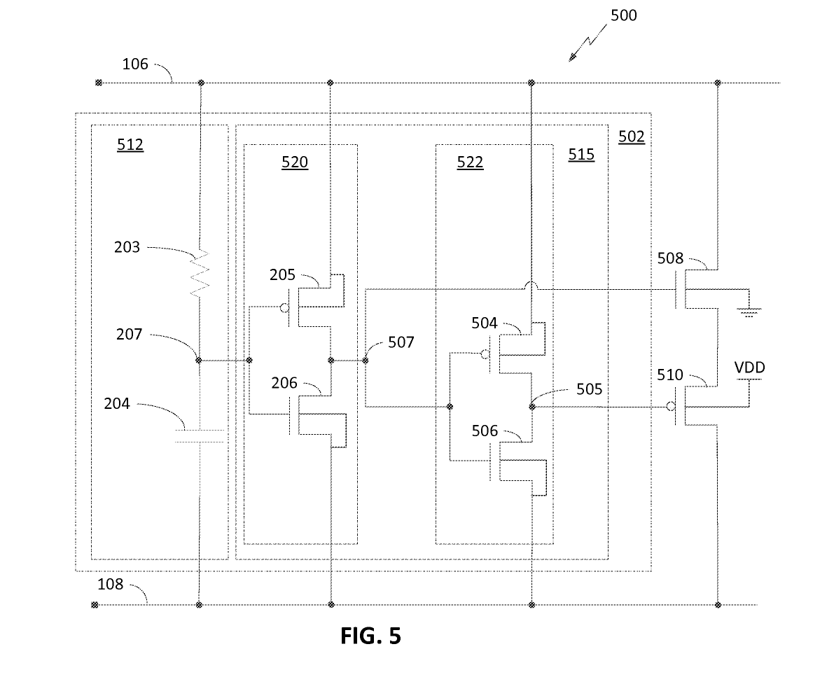

FIG. 5 shows an example of an ESD rail clamp 500 having series transistors in the discharging path. The ESD rail clamp 500 includes an ESD trigger circuit 502 and discharging transistors 508 and 510. The ESD trigger circuit 502 is coupled in parallel to discharging transistors 508 and 510, which are coupled in series. The ESD trigger circuit 502 may include an RC network 512 for detecting an ESD event on the power supply rails, and a control circuit 515 configured to turn on discharging transistors 508 and 510 when the RC network 512 detects an ESD event and turn off discharging transistors 508 and 510 when an ESD event is not detected. In some aspects, discharging transistor 508 is an NMOS transistor with a body coupled to ground and discharging transistor 510 is a PMOS transistor with a body coupled to the supply voltage (e.g., VDD) or with a body coupled to the source of the PMOS transistor.

In some aspects, the control circuit 515 includes transistors 205 and 206 coupled in series and transistors 504 and 506 coupled in series. In some aspects, transistor 205 is a PMOS transistor and transistor 206 is an NMOS transistor to form a first inverter stage 520, and transistor 504 is a PMOS transistor and transistor 506 is an NMOS transistor to form a second inverter stage 522. The gate nodes of transistors 205 and 206 are commonly coupled to node 207 and the drain nodes of transistors 205 and 206 are commonly coupled to the gate nodes of transistors 504 and 506 and the gate node of discharging transistor 508. In some aspects, the drain nodes of transistors 504 and 506 are commonly coupled to the gate node of discharging transistor 510. In some implementations, the body of each transistor 205, 206, 504 and 506 is coupled to the source node of the respective transistor.

During normal operation, the ESD trigger circuit 502 keeps discharging transistors 508 and 510 turned off. This is because the RC network 512 passes the supply voltage on power supply rail 106 to node 207 by charging capacitor 204 to the supply voltage. This causes the first inverter stage 520 to pull node 507 low, which keeps discharging transistor 508 turned off. This also causes the second inverter stage 522 to pull node 505 high, which keeps discharging transistor 510 turned off. In contrast to FIG. 2, the ESD rail clamp 500 splits the supply voltage across discharging transistors 508 and 510 to reduce the amount of leakage current produced during normal operation.

In some aspects, the ESD rail clamp 500 is configured to provide ESD protection to internal circuit 102 when power supply rail 106 is powered off (e.g., during manufacturing and/or handling of the device incorporating internal circuit 102). In this aspect, when an ESD event is not present, node 207 is at zero potential and discharging circuits 508 and 510 are turned off since power supply rail 106 is powered off.

However, during an ESD event occurring when power supply rail 106 is powered off (e.g., during manufacturing and/or handling of the device incorporating internal circuit 102), the ESD trigger circuit 502 turns on discharging transistors 508 and 510 to provide the low resistance shunt path from power supply rail 106 to power supply rail 108. In particular, the RC network 512 blocks the high-frequency components of the ESD current, thus keeping the voltage at node 207 at zero potential. However, the ESD voltage rises above the threshold voltage of the transistor 205, causing transistor 205 to turn on. In some aspects, the transistor 206 remains turned off during the ESD event. As a result, transistor 205 pulls node 507 high (e.g., to the voltage value of the power supply rail 106), causing discharging transistor 508 (e.g., NMOS transistor) to turn on and transistor 506 of the second inverter stage 522 to turn on. This causes the transistor 506 to pull node 505 low (e.g., to the voltage value of the power supply rail 108), causing discharging transistor 508 (e.g., PMOS transistor) to turn on to complete the low resistance shunt path between the power supply rails 106 and 108.

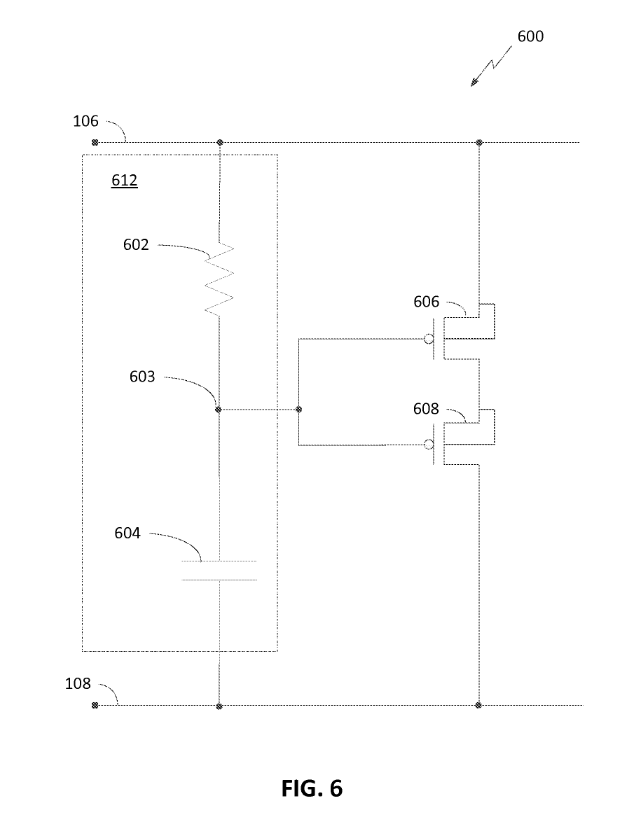

FIG. 6 shows an example of an ESD rail clamp 600 having series transistors in the discharging path. The ESD rail clamp 600 includes an ESD trigger circuit 612 and discharging transistors 606 and 608. As shown in FIG. 6, the trigger circuit 612 may be an RC network comprising a resistor 602 and a capacitor 604 coupled in series and coupled between the power supply rails 106 and 108. The RC network behaves as a low-pass filter at node 603 and is coupled to the gate nodes of discharging transistors 606 and 608 at node 603. In this example, the RC network directly drives the gate nodes of discharging transistor 606 and 608. In some aspects, discharging transistors 606 and 608 may include two PMOS transistors coupled in series. In some implementations, the bodies (e.g., N-well) of discharging transistors 606 and 608 share a same N-well, or can be formed in two different N-wells that are tied to their respective sources.

During normal operation, the RC network keeps the discharging transistors 606 and 608 turned off. This is because the RC network passes the supply voltage on power supply rail 106 to node 603, which is coupled to the gate nodes of discharging transistors 606 and 608. The high voltage at node 603 turns off discharging transistors 606 and 608.

In some aspects, the ESD rail clamp 600 is configured to provide ESD protection to internal circuit 102 when power supply rail 106 is powered off (e.g., during manufacturing and/or handling of the device incorporating internal circuit 102). In this aspect, when an ESD event is not present, node 603 is at zero potential and discharging circuit 606 and 608 are turned off since power supply rail 106 is powered off.

However, during an ESD event occurring when power supply rail 106 is powered off (e.g., during manufacturing and/or handling of the device incorporating internal circuit 102), the RC network turns on the discharging transistors 606 and 608 to provide the low resistance shunt path from power supply rail 106 to power supply rail 108. In particular, the RC network blocks the high-frequency components of the ESD current thus keeping the voltage at node 603 at zero potential. However, the ESD voltage rises above the absolute threshold voltage of discharging transistor 606, causing the discharging transistor 606 to turn on, which in turn causes the source node of discharging transistor 608 to be pulled high (e.g., to the voltage value of the power supply rail 106). In this respect, the voltage difference between the source node and the gate node of discharging transistor 608 rises above the absolute threshold voltage of discharging transistor 608, causing discharging transistor 608 to turn on to complete the low resistance shunt path between the power supply rails 106 and 108.

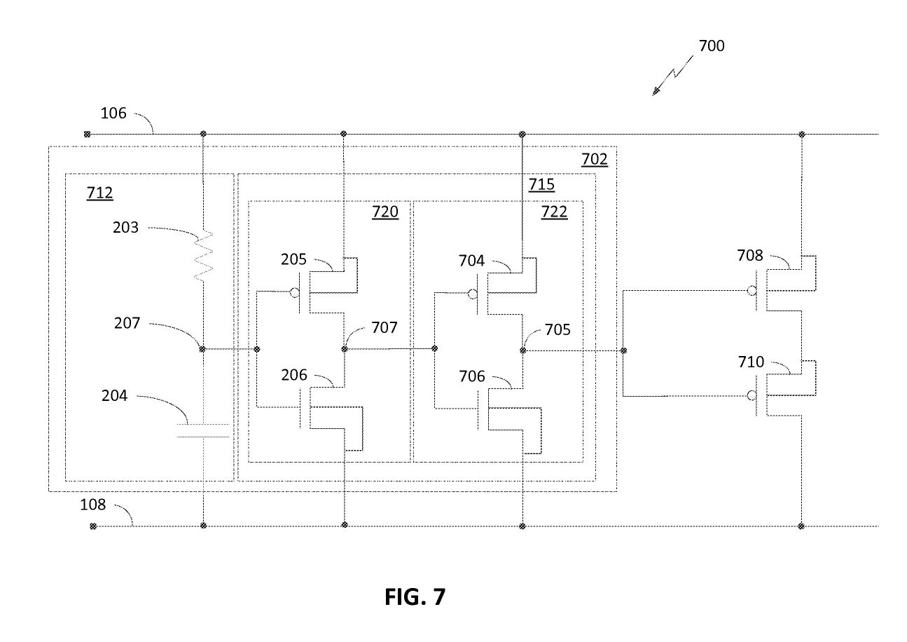

FIG. 7 shows an example of an ESD rail clamp 700 having series transistors in the discharging path. The ESD rail clamp 700 includes an ESD trigger circuit 702 and series discharging transistors 708 and 710. The ESD trigger circuit 702 is coupled in parallel to discharging transistors 708 and 710. The ESD trigger circuit 702 may include an RC network 712 for detecting an ESD event on the power supply rails, and a control circuit 715 configured to turn on discharging transistors 708 and 710 when the RC network 712 detects an ESD event and turn off discharging transistors 708 and 710 when an ESD event is not detected. In some aspects, discharging transistors 708 and 710 are PMOS transistors coupled in series.

The RC network 712 is coupled between power supply rail 106 and power supply rail 108. The RC network 712 includes a resistor 203 and a capacitor 204. The resistor 203 and capacitor 204 may be coupled in series between power supply rail 106 and power supply rail 108 such that the RC network 712 behaves as a low-pass filter at node 207.

As shown in FIG. 7, control circuit 715 includes transistors 205 and 206 coupled in series and transistors 704 and 706 coupled in series. In some aspects, transistor 205 is a PMOS transistor and transistor 206 is an NMOS transistor to form a first inverter stage 720, and transistor 704 is a PMOS transistor and transistor 706 is an NMOS transistor to form a second inverter stage 722. The gate nodes of transistors 205 and 206 are commonly coupled to node 207 and the drain nodes of transistors 205 and 206 are commonly coupled to the gate nodes of transistors 704 and 706. In some aspects, the drain nodes of transistors 704 and 706 are commonly coupled to the gate nodes of the discharging transistors 708 and 710. In some implementations, the body of each transistor 205, 206, 704 and 706 is coupled to the source node of the respective transistor.

During normal operation, the ESD trigger circuit 702 keeps discharging transistors 708 and 710 turned off. This is because the RC network 712 passes the supply voltage to node 207, which cases the first inverter stage 720 to pull node 707 low, and the second inverter stage 722 to pull node 705 high. The high voltage at node 705 turns off the discharging transistors 708 and 710.

In some aspects, the ESD rail clamp 700 is configured to provide ESD protection to internal circuit 102 when power supply rail 106 is powered off (e.g., during manufacturing and/or handling of the device incorporating internal circuit 102). In this aspect, when an ESD event is not present, node 207 is at zero potential and discharging circuit 708 and 710 are turned off since power supply rail 106 is powered off.

However, during an ESD event occurring when power supply rail 106 is powered off (e.g., during manufacturing and/or handling of the device incorporating internal circuit 102), the ESD trigger circuit 702 turns on the discharging transistors 708 and 710 to provide the low resistance shunt path from power supply rail 106 to power supply rail 108. In particular, the RC network 712 blocks the high-frequency components of the ESD current thus keeping the voltage at node 207 at zero potential. However, the ESD voltage rises above the absolute threshold voltage of transistor 205, causing transistor 205 to turn on. As a result, transistor 205 pulls node 707 high (e.g., to the voltage value of the power supply rail 106), causing transistor 706 (e.g., NMOS transistor) of the second inverter stage 722 to turn on. This causes transistor 706 to pull node 705 low (e.g., to the voltage value of the power supply rail 108), causing discharging transistors 708 and 710 (e.g., PMOS transistors) to turn on to complete the low resistance shunt path between the power supply rails 106 and 108. In some aspects, transistors 206 and 704 remain turned off during the ESD event.

The ESD rail clamp 700 in FIG. 7 differs from the ESD rail clamp 600 in FIG. 6 in that the ESD rail claim 700 includes two inverter stages 720 and 722 between the RC network 712 and the discharging transistors 708 and 710. The two inverter stages 720 and 722 provide gate drive gain that turns on the discharging transistors 708 and 710 harder during an ESD event (and therefore increases conductivity of the shunt path) for a given RC network.

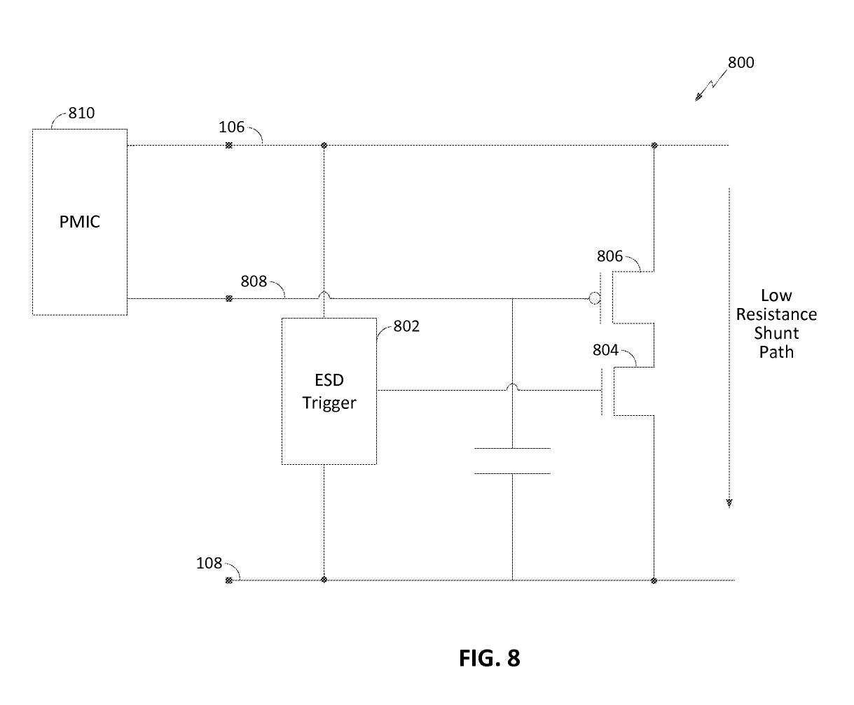

FIG. 8 shows an example of an ESD rail clamp 800 having series transistors in the discharging path. The ESD rail clamp 800 includes an ESD trigger circuit 802 and discharging transistors 804 and 806. In some aspects, discharging transistor 804 comprises an NMOS transistor and discharging transistor 806 comprises a PMOS transistor with a gate node coupled to a third power supply rail 808.

When the power supply rails 106, 108 and 808 are powered off, the third power supply rail 808 is approximately grounded by capacitive coupling to power supply rail 108. The capacitive coupling may be provided by one or more capacitors (e.g., decaps) coupled between the third power supply 808 and power supply rail 108. When the power supply rails 106 and 808 are powered up during a power-up sequence, the third power supply rail 808 may be powered up first (e.g., before power supply rail 106) to keep discharging PMOS 806 transistor turned off during the power-up sequence. The power supply rails 106 and 808 may be powered up by a power management integrated circuit (PMIC) 810. In some aspects, the voltage difference between power supply rail 106 and the third power supply rail 808 after the power-up sequence is less than the absolute threshold voltage of discharging transistor 806 to keep discharging transistor 806 turned off during normal operation.

During normal operation, the ESD trigger circuit 802 keeps discharging transistor 804 turned off. In particular, the ESD trigger circuit 802 pulls the gate of discharging transistor 804 low during normal operation.

In some aspects, the ESD rail clamp 800 is configured to provide ESD protection to internal circuit 102 when power supply rail 106 and the third power supply rail 808 are powered off (e.g., during manufacturing and/or handling of the device incorporating internal circuit 102). In this aspect, when an ESD event is not present, the third power supply rail 808 is at zero potential, keeping discharging circuit 806 turned off. In addition, the EDS trigger circuit 802 keeps discharging transistor 804 turned off.

However, during an ESD event occurring when power supply rail 106 is powered off (e.g., during manufacturing and/or handling of the device incorporating internal circuit 102), the voltage on power supply rail 106 rises above the absolute threshold voltage of discharging transistor 806, causing discharging transistor 806 to turn on. In addition, the ESD trigger circuit 802 turns on discharging transistor 804 to complete the low resistance shunt path from power supply rail 106 to power supply rail 108. The ESD trigger circuit 802 may correspond to ESD trigger circuit 202 (shown in FIG. 2).

As discussed above, during a power-up sequence, the PMIC 810 may power up the third power supply 808 before power supply rail 106 to keep discharging transistor 806 turned off. The PMIC 810 may be external to the die comprising the ESD rail clamp 800, and may be coupled to the die via external power lines (e.g., printed circuit board (PCB) traces). Although not shown in FIG. 8, power supply rail 108 may also be coupled to the PMIC 810. The PMIC 810 may power up the third power supply rail 808 before power supply rail 108 during the power-up sequence.

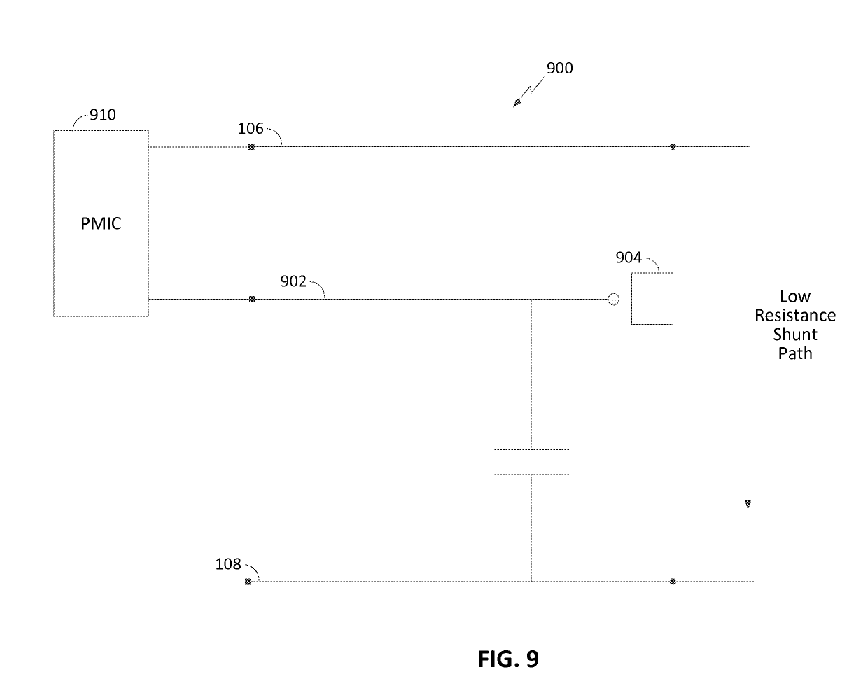

FIG. 9 shows an example of an ESD rail clamp 900 including a discharging transistor 904. The discharging transistor 904 may comprise a PMOS transistor with a gate node coupled to the third power supply rail 902.

When the power supply rails 106, 108 and 902 are powered off, the third power supply rail 902 is approximately grounded by capacitive coupling to power supply rail 108. During an ESD event, the voltage on power supply rail 106 rises above the absolute threshold voltage of discharging transistor 904, causing the discharging transistor 904 to turn on and form the low resistance shunt path.

When the power supply rails 106 and 902 are powered up during a power-up sequence, the third power supply rail 902 may be powered up first (e.g., before power supply rail 106) to keep the discharging 904 transistor turned off during the power-up sequence. The power supply rails 106 and 902 may be powered up by a power management integrated circuit (PMIC) 910. In some aspects, the voltage difference between power supply rail 106 and the third power supply rail 902 after the power-up sequence is less than the absolute threshold voltage of discharging transistor 904 to keep discharging transistor 904 turned off during normal operation. Although not shown in FIG. 9, power supply rail 108 may also be coupled to the PMIC 910. The PMIC 910 may power up the third power supply rail 902 before power supply rail 108 during the power-up sequence.

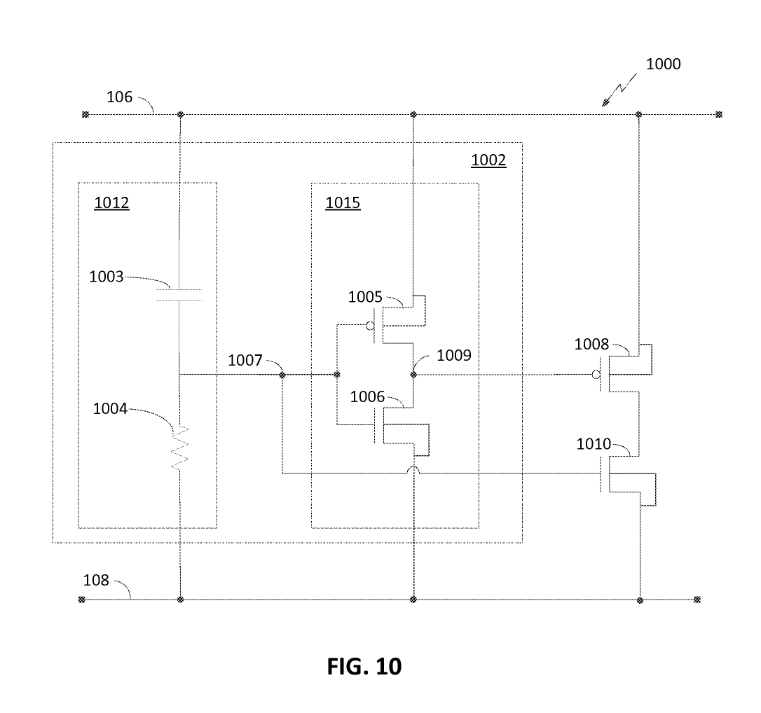

FIG. 10 shows an example of an ESD rail clamp 1000 having series transistors in the discharging path. The ESD rail clamp 1000 includes an ESD trigger circuit 1002 and discharging transistors 1008 and 1010. The ESD trigger circuit 1002 is coupled in parallel to discharging transistors 1008 and 1010. The ESD trigger circuit 1002 includes an RC network 1012 for detecting an ESD event on the power supply rails, and a control circuit 1015 configured to turn on discharging transistors 1008 and 1010 when the RC network 1012 detects an ESD event and turn off the discharging transistors 1008 and 1010 when an ESD event is not detected. In some aspects, discharging transistor 1008 is a PMOS transistor and discharging transistor 1010 is an NMOS transistor.

The RC network 1012 is coupled between power supply rail 106 and power supply rail 108. The RC network 1012 includes a capacitor 1003 and resistor 1004. The capacitor 1003 and the resistor 1004 may be coupled in series between power supply rail 106 and power supply rail 108 such that the RC network 1012 behaves as a high-pass filter at node 1007. In this respect, the capacitor 1003 is coupled between the power supply rail 106 and node 1007, while the resistor 1004 is coupled between the power supply rail 108 and node 1007. The RC network 1012 blocks the supply voltage on power supply rail 106 from node 1007 while passing an ESD voltage to node 1007.

As shown in FIG. 10, the control circuit 1015 includes transistors 1005 and 1006 coupled in series. In some aspects, transistor 1005 is a PMOS transistor and transistor 1006 is an NMOS transistor to form an inverter stage. The gate nodes of transistors 1005 and 1006 are commonly coupled to node 1007 and the drain nodes of transistors 1005 and 1006 are commonly coupled to the gate node of discharging transistor 1008. In some aspects, node 1007 is also coupled to the gate node of discharging transistor 1010. In some implementations, the body of each transistor 1005 and 1006 is coupled to the source node of the respective transistor. In some aspects, the body of discharging transistor 1008 is coupled to either the power supply rail 106 or source node of discharging transistor 1008.

During normal operation, the ESD trigger circuit 1002 keeps discharging transistors 1008 and 1010 turned off. This is because the RC network 1012 blocks the supply voltage on power supply rail 106 from node 1007, keeping node 1007 low. The low voltage at node 1007 turns on transistor 1005 of the inverter stage, causing transistor 1005 to pull the gate node of discharging transistor 1008 high. This keeps discharging transistor 1008 turned off. The low voltage at node 1007 keeps discharging transistor 1010 turned off.

In some aspects, the ESD rail clamp 1000 is configured to provide ESD protection to internal circuit 102 when power supply rail 106 is powered off (e.g., during manufacturing and/or handling of the device incorporating internal circuit 102). In this aspect, when an ESD event is not present, node 1007 is at zero potential and discharging circuit 1008 and 1010 are turned off since power supply rail 106 is powered off.

However, during an ESD event occurring when power supply rail 106 is powered off (e.g., during manufacturing and/or handling of the device incorporating internal circuit 102), the ESD trigger circuit 1002 turns on discharging transistors 1008 and 1010 to provide the low resistance shunt path from power supply rail 106 to power supply rail 108. In particular, the RC circuit 1012 allows the ESD voltage to pass to node 1007, thus driving the voltage at node 1007 up to a high potential (e.g., the supply voltage of the power supply rail 106). This causes transistor 1006 to turn on. In some aspects, transistor 1005 remains turned off during the ESD event. As a result, transistor 1006 pulls node 1009 low (e.g., to the voltage value of the power supply rail 108), causing discharging transistor 1008 (e.g., PMOS) to turn on. The high voltage at node 1007 turns on discharging transistor 1010 (e.g., NMOS) to complete the low resistance shunt path between the power supply rails 106 and 108.

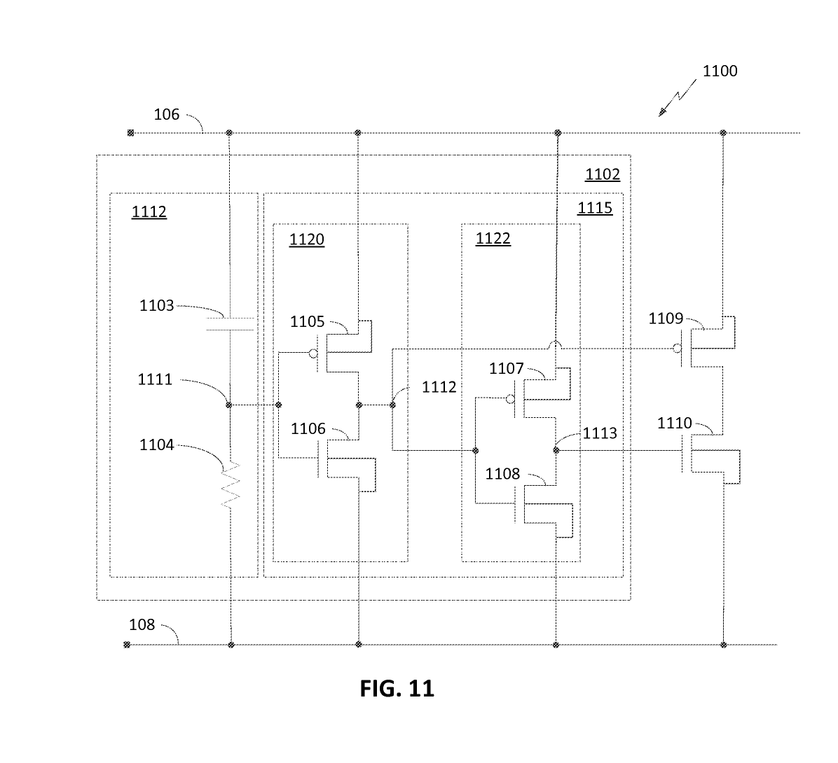

FIG. 11 shows an example of an ESD rail clamp 1100 having series transistors in the discharging path. The ESD rail clamp 1100 includes an ESD trigger circuit 1102 and discharging transistors 1109 and 1110. The ESD trigger circuit 1102 is coupled in parallel to discharging transistors 1109 and 1110. The ESD trigger circuit 1102 includes an RC network 1112 for detecting an ESD event on the power supply rails, and a control circuit 1115 configured to turn on discharging transistors 1109 and 1110 when the RC network 1112 detects an ESD event and turn off discharging transistors 1109 and 1110 when an ESD event is not detected. In some aspects, discharging transistor 1109 is a PMOS transistor and the discharging transistor 1110 is an NMOS transistor.

The RC network 1112 is coupled between power supply rail 106 and power supply rail 108. The RC network 1112 includes a capacitor 1103 and resistor 1104. The capacitor 1103 and the resistor 1104 may be coupled in series between power supply rail 106 and power supply rail 108 such that the RC network 1112 behaves as a high-pass filter at node 1111. In this respect, the capacitor 1103 is coupled between the power supply rail 106 and node 1111, while the resistor 1104 is coupled between the power supply rail 108 and node 1111. The RC network 1112 is configured to block the supply voltage on power supply rail 106 from node 1111 and pass an ESD voltage to node 1111.

As shown in FIG. 11, the control circuit 1115 includes transistors 1105 and 1106 coupled in series and transistors 1107 and 1108 coupled in series. In some aspects, transistor 1105 is a PMOS transistor and transistor 1106 is an NMOS transistor to form a first inverter stage 1120, and transistor 1107 is a PMOS transistor and transistor 1108 is an NMOS transistor to form a second inverter stage 1122. The gate nodes of transistors 1105 and 1106 are commonly coupled to node 1111 and the drain nodes of transistors 1105 and 1106 are commonly coupled to the gate nodes of transistors 1107 and 1108 and the gate node of discharging transistor 1109. In some aspects, the drain nodes of transistors 1107 and 1108 are commonly coupled to the gate node of discharging transistor 1110. In some implementations, the body of each transistor 1105-1108 is coupled to the source node of the respective transistor.

During normal operation, the ESD trigger circuit 1102 keeps discharging transistors 1109 and 1110 turned off. This is because the RC network 1112 blocks the supply voltage on power supply rail 106 from node 1111, keeping node 1111 low. The low voltage at node 1111 causes the second inverter stage 1122 to pull the gate node of discharging transistor 1110 low, keeping discharging transistor 1110 turned off. The low voltage at node 1111 also causes the first inverter stage 1120 to pull the gate node of discharging transistor 1109 high, keeping the discharging transistor 1109 turned off.

In some aspects, the ESD rail clamp 1100 is configured to provide ESD protection to internal circuit 102 when power supply rail 106 is powered off (e.g., during manufacturing and/or handling of the device incorporating internal circuit 102). In this aspect, when an ESD event is not present, node 1111 is at zero potential and discharging circuit 1109 and 1110 are turned off since power supply rail 106 is powered off.

However, during an ESD event occurring when power supply rail 106 is powered off (e.g., during manufacturing and/or handling of the device incorporating internal circuit 102), the ESD trigger circuit 1102 turns on the discharging transistors 1109 and 1110 to provide the low resistance shunt path from the power supply rail 106 to the power supply rail 108. In particular, the RC network 1112 allows the ESD voltage to pass to node 1111, thus driving the voltage at node 1111 up to a high potential (e.g., the supply voltage of the power supply rail 106), causing transistor 1106 to turn on. Transistor 1106 pulls node 1112 low (e.g., to the voltage value of the power supply rail 108), causing discharging transistor 1109 (e.g., PMOS transistor) to turn on and transistor 1107 of the second inverter stage 1122 to turn on. Transistor 1107 pulls node 1113 high (e.g., to the voltage value of the power supply rail 106), causing discharging transistor 1110 (e.g., NMOS transistor) to turn on to complete the low resistance shunt path between the power supply rails 106 and 108. In some aspects, transistors 1105 and 1108 remain turned off during the ESD event.

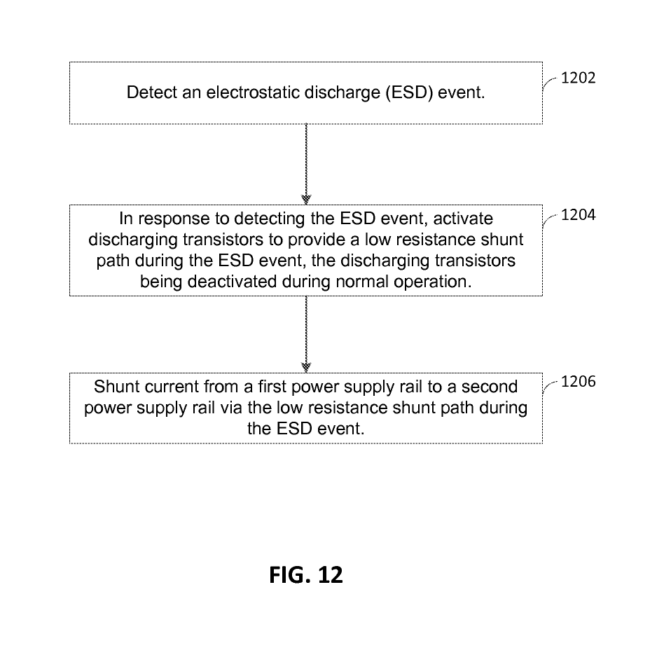

FIG. 12 is a flowchart illustrating an example of a method 1200 of shunting ESD current between voltage power supply rails in accordance with one or more embodiments of the subject technology. In some embodiments, the method 1200 may be performed by one of the clamp circuits of FIGS. 3-11.

The method 1200 includes a process 1202 for detecting an electrostatic discharge (ESD) event. In response to detecting the ESD event, the method 1200 includes a process 1204 for activating multiple discharging transistors to provide a low resistance shunt path during the ESD event. In some aspects, the low resistance shunt path is formed by the discharging transistors. The discharging transistors may all be deactivated during normal operation. The method 1200 also includes a process 1206 for shunting ESD current from a first power supply rail to a second power supply rail via the low resistance shunt path during the ESD event.

The method 1200 may include a process for providing a supply voltage to at least one of the plurality of discharging transistors from a third power supply rail. In this regard, the third power supply rail may be powered on before at least one of the first and second power supply rails during a power-up sequence to keep the at least one of the discharging transistors turned off during the power-up sequence.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A circuit comprising:
an internal circuit; and
an electrostatic discharge (ESD) rail clamp coupled in parallel to the internal circuit and between first and second power supply rails, wherein the ESD rail clamp is operable to shunt ESD current from the first power supply rail to the second power supply rail via a low resistance shunt path, wherein the ESD rail clamp comprises:
an ESD trigger circuit configured to detect an ESD event; and
a plurality of discharging transistors coupled in series between the first and second power supply rails, wherein the ESD trigger circuit is configured to turn off the plurality of discharging transistors during normal operation and to turn on the plurality of discharging transistors to form the low resistance shunt path in response to detection of the ESD event.

2. The circuit of claim 1, wherein the plurality of discharging transistors comprises a PMOS transistor and an NMOS transistor.

3. The circuit of claim 1, wherein the plurality of discharging transistors comprises a plurality of PMOS transistors.

4. The circuit of claim 1, wherein the plurality of discharging transistors comprise a PMOS transistor with a gate coupled to a third power supply rail, and the circuit further comprises a power management circuit configured to power up the third power supply rail before at least one of the first and second power supply rails during a power-up sequence.

5. The circuit of claim 1, wherein the ESD trigger circuit comprises:
a resistor-capacitor (RC) network coupled between the first and second power supply rails, wherein the RC network is configured to detect the ESD event; and
a control circuit configured to turn on the plurality of discharging transistors in response to detection of the ESD event by the RC network.

6. The circuit of claim 5, wherein the RC network comprises a resistor coupled between the first power supply rail and an input of the control circuit, and a capacitor coupled between the input of the control circuit and the second power supply rail.

7. The circuit of claim 5, wherein the RC network comprises a capacitor coupled between the first power supply rail and an input of the control circuit, and a resistor coupled between the input of the control circuit and the second power supply rail.

8. The circuit of claim 5, wherein the control circuit comprises a first inverter and a second inverter, the RC network is coupled to an input of the first inverter, and an input of the second inverter is coupled to an output of the first inverter.

9. The circuit of claim 8, wherein the plurality of discharging transistors comprises a PMOS transistor and an NMOS transistor, the PMOS transistor has a source coupled to the first power supply rail and a gate coupled to an output of the second inverter, and the NMOS transistor has a source coupled to the second power supply rail and a gate coupled to the output of the first inverter.

10. The circuit of claim 8, wherein the plurality of discharging transistors comprises a PMOS transistor and an NMOS transistor, the PMOS transistor has a drain coupled to the second power supply rail and a gate coupled to an output of the second inverter, and the NMOS transistor has a drain coupled to the first power supply rail and a gate coupled to the output of the first inverter.

11. The circuit of claim 8, wherein the plurality of discharging transistors comprise first and second PMOS transistors coupled in series between the first and second power supply rails, and the first and second PMOS transistors have gates coupled to an output of the second inverter.

12. The circuit of claim 5, wherein the control circuit comprises an inverter, the RC network is coupled to an input of the inverter and a gate of one of the discharging transistors, and an output of the inverter is coupled to a gate of another one of the discharging transistors.

13. A method comprising:
detecting an electrostatic discharge (ESD) event;
in response to detecting the ESD event, activating a plurality of discharging transistors to provide a low resistance shunt path during the ESD event, wherein the plurality of discharging transistors are deactivated during normal operation; and
shunting ESD current from a first power supply rail to a second power supply rail via the low resistance shunt path during the ESD event.

14. The method of claim 13, wherein a gate of at least one of the plurality of discharging transistors is coupled to a third power supply rail, and wherein the method further comprising powering up the third power supply rail before at least one of the first and second power supply rails during a power-up sequence to keep the at least one of the plurality of discharging transistors turned off during the power-up sequence.

15. The method of claim 13, wherein the plurality of discharging transistors comprises a PMOS transistor and an NMOS transistor.

16. The method of claim 13, wherein the plurality of discharging transistors comprises a plurality of PMOS transistors.

17. An apparatus comprising:
means for detecting an electrostatic discharge (ESD) event;
means for powering on a plurality of discharging transistors during the ESD event, wherein the plurality of discharging transistors are deactivated during normal operation; and
means for shunting ESD current from a first power supply rail to a second power supply rail via the plurality of discharging transistors during the ESD event.

18. The apparatus of claim 17, wherein a gate of at least one of the plurality of discharging transistors is coupled to a third power supply rail, and the apparatus further comprises means for powering up the third power supply rail before at least one of the first and second power supply rails during a power-up sequence to keep the at least one of the plurality of discharging transistors turned off during the power-up sequence.

19. The apparatus of claim 17, wherein the plurality of discharging transistors comprises a PMOS transistor and an NMOS transistor.

20. The apparatus of claim 17, wherein the plurality of discharging transistors comprise a plurality of PMOS transistors.
